(19) United States
(12) Patent Application Publication
(10) Pub. No.: US 2007/0220129 A1
(43) Pub. Date: Sep. 20, 2007

(54) Method of granting control of device and device using the method

(75) Inventor: Won-seok Kwon, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/599,412

(22) Filed: Nov. 15, 2006

(30) Foreign Application Priority Data
Feb. 24, 2006 (KR) 10-2006-0018430

(51) Int. Cl. G06F 15/16; G06F 15/173

(52) U.S. Cl. 709/223; 709/205

(57) ABSTRACT

A universal plug and play (UPnP) device that grants a control point (CP) to control a device is provided. It is determined that the CP joined a domain joined by the device to selectively allow the CP to control the device, thereby allowing only a specific CP to control the device. Also disclosed are a method of operating the device and a computer readable recording medium having recorded thereon a program for allowing a computer to execute the method.

This application claims priority from Korean Patent Application No. 10-2006-0018430, filed on Feb. 24, 2006, in the Korean Intellectual Property Office, the disclosure of which is incorporated herein in its entirety by reference.

### BACKGROUND OF THE INVENTION

1. Field of the Invention

The present invention relates to a universal plug and play (UPnP), and more particularly to, a UPnP network comprising a UPnP device and a control point (CP).

2. Description of the Related Art

Personal computers (PCs) that have WINDOWS as an operating system (OS) can automatically recognize peripheral devices using a universal plug and play (UPnP) function. Therefore, users can easily install peripheral devices. UPnP is one protocol that extends such a function to networks to allow networked electric appliances to automatically recognize one another.

FIGS. 1A and 1B are block diagrams of a conventional UPnP network 120. Referring to FIGS. 1A and 1B, the UPnP network 120 comprises control points (CPs) 100 and devices 110. The devices 110 are controlled devices providing a specific service. The CPs 100 control the service provided by the devices 110 to obtain a result desired by a user.

The CPs 100 perform a discovery 130 for searching for the devices 110 that control the service using two methods as described below. First, if the CPs 100 multicast an M-SEARCH SSDP message via an HTTP transport protocol, the devices 110 receive the M-SEARCH SSDP message. Second, if the devices 110 join the UPnP network 120 and multicast a NOTIFY SSDP message via the HTTP transport protocol, the CPs 100 receive the NOTIFY SSDP message.

After the discovery process, the devices 110 perform a subscription 140 for transporting information about the devices 110 and services provided by the devices 110. The CPs 100 obtain a first XML document including information about the devices 110 from the subscription 140 via a device contact uniform resource identifier (URI) obtained from the discovery 130 using a HTTP GET method, and a second XML including the information about the services provided by the devices 110 via the first XML document.

The CPs 100 perform a control 150 of the devices 110 after obtaining the information about the services. Controllable services are provided by actions. The information about the services includes definitions of various actions. The CPs 100 prepare an SOAP message calling the actions based on the information about the service and transport the SOAP message to the devices 110 via the HTTP transport protocol through the control 150. The devices 110 receive the SOAP message, perform an operation for the action, and transport a result obtained by calling the action to the CPs 100.

The devices 110 perform an eventing 160 for informing the CPs 100 of a value of a changed eventing parameter of the devices 110 via a GENA message. The devices 110 transport the GENA message to only the CPs 100 that registered a receipt of a message in advance.

According to the conventional UPnP network 120, when the CPs 100 connected to the devices 110 via the UPnP network 120 discover 130 the devices 110, the CPs 100 perform the control 150 of the devices 110 regardless of whether the CPs 110 are authorized to control the devices 110. However, since the UPnP network is extended to mobile and networked products such as smart phones, PDAs, etc., a new UPnP network in which a specific CP among CPs connected to devices via a network can control the devices is required.

### SUMMARY OF THE INVENTION

The present invention provides a method of granting control of a device that allows a specific control point (CP) joining a domain including the device to selectively control the device and a device using the method.

According to an aspect of the present invention, there is provided a method of granting control of a specific device to a control point (CP) that controls at least one device, the method comprising: determining whether the CP joined a domain joined by the specific device; and allowing the CP to selectively control the specific device according to a result obtained by the determination.

According to another aspect of the present invention, there is provided a computer readable recording medium storing a program for executing the method.

According to another aspect of the invention, there is provided a device that grants control to a CP that controls at least one device, the device comprising: a CP determiner determining whether the CP joined a domain joined by the device; and a control allowing unit allowing the CP to selectively control the device in response to a result obtained by the determination.

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B are block diagrams of a conventional UPnP network;

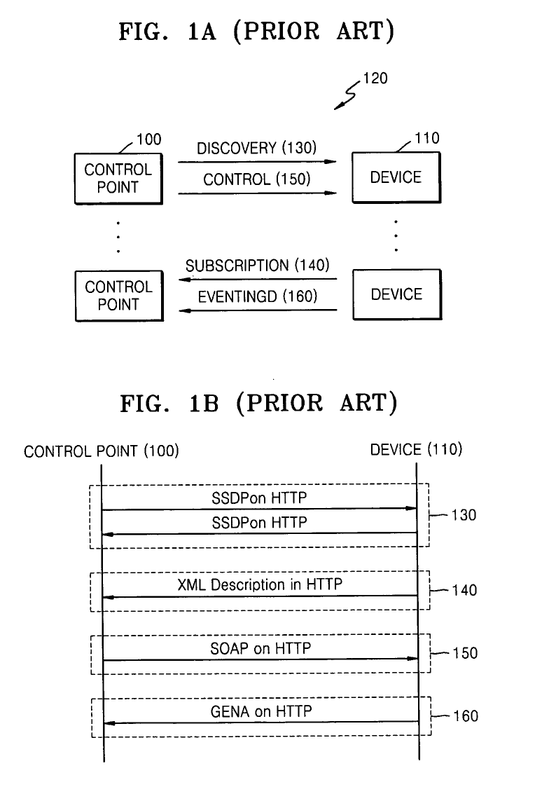

FIG. 2 is a block diagram of a method of granting control of a device and a device using the method according to an embodiment of the present invention;

FIG. 3A is a flowchart of a join operation of the method of granting control of the device according to an embodiment of the present invention;

FIG. 3B illustrates a join message used in the method of granting control of the device according to an embodiment of the present invention;

FIG. 4A is a flowchart of a control operation of the method of granting control of the device according to an embodiment of the present invention;

FIG. 4B illustrates a control message used in the method of granting control of the device according to an embodiment of the present invention;

FIG. 5A is a flowchart of a subscription operation of the method of granting control of the device according to an embodiment of the present invention;

FIG. 5B illustrates a subscription message used in the method of granting control of the device according to an embodiment of the present invention;

FIG. 6A is a flowchart of a leave operation of the method of granting control of the device according to an embodiment of the present invention;

FIG. 6B illustrates a leave message used in the method of granting control of the device according to an embodiment of the present invention; and

FIG. 7 is a block diagram of a device according to an embodiment of the present invention.

### DETAILED DESCRIPTION OF THE INVENTION

The present invention will now be described more fully with reference to the accompanying drawings.

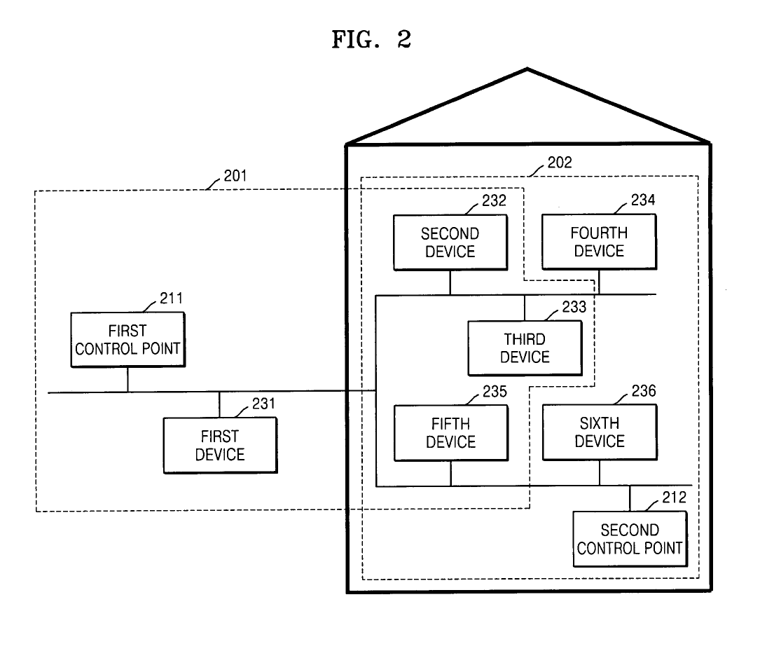

FIG. 2 is a block diagram of a method of granting control of a device and a device using the method according to an embodiment of the present invention. Referring to FIG. 2, first through sixth devices 231 through 236 are controlled devices for first and second control points (CPs) 211 and 212 and provide a specific service. The first and second CPs 211 and 212 control the services provided by the first through sixth devices 231 through 236 and obtain a result desired by a user.

The first through sixth devices 231 through 236 and the first and second CPs 211 and 212 are connected to a network in which the first CP 211, the first, second, third, and fifth devices 231, 232, 233, and 235 join a first domain 201, and the second CP 212 and the second through sixth devices 232 through 236 join a second domain 202.

According to a UPnP network using the method of granting control of the device and the device using the method according to a current embodiment of the present invention, a CP that joins the same domain as that of a device among CPs connected to the devices through a network can control the device. For example, the first CP 211 can control the first, second, third, and fifth devices 231, 232, 233, and 235 that join the first domain 201. However, since the first CP 211 does not join the second domain 202, the first CP 211 cannot control the fourth and sixth devices 234 and 236 connected via the network. Also, the second CP 212 can control the second through sixth devices 232 through 236 that join the second domain 202. However, since the second CP 212 does not join the first domain 201, the second CP 212 cannot control the first device 231.

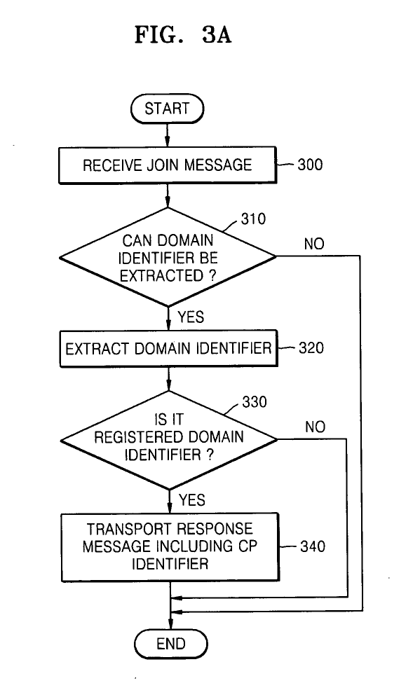

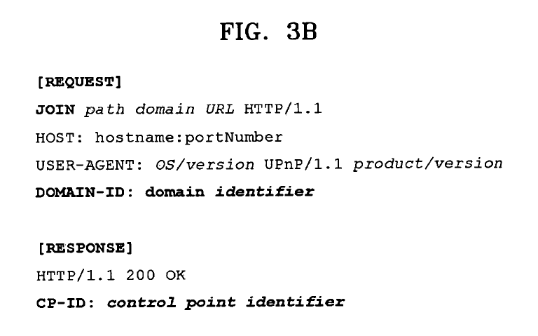

FIG. 3A is a flowchart of a joining operation of the method of granting control of the device according to an embodiment of the present invention. Referring to FIG. 3A, the device receives a join message from the control point CP (Operation 300). A [REQUEST] message illustrated in FIG. 3B is the join message. The join message, which is a message for joining a specific domain, includes a domain identifier DOMAIN-ID indicating the specific domain that identifies a UPnP network.

The domain identifier is determined beyond the scope of aUPnP protocol. Secrecy of the domain identifier is maintained beyond the scope of the UPnP protocol. All UPnP devices joining a domain have the same domain identifier. The domain identifier of the CP for joining a UPnP network is predetermined. An outside user determines a domain of the device.

The device determines whether to extract the domain identifier from the join message (Operation 310).

If the device determines that the domain identifier cannot be extracted from the join message, since the join message does not has a field of the domain identifier, the CP cannot join the domain. The device does not respond to the join message.

If the device determines that the domain identifier can be extracted from the join message, the device extracts the domain identifier from the join message (Operation 320).

The device determines whether the domain identifier is registered with a list of domain identifiers (Operation 330). The list of the domain identifiers indicates a list including the domain identifiers joined by the device.

If the device determines that the domain identifier is not registered with the list of domain identifiers, the CP cannot join the domain. The device does not respond to the join message because a domain to be joined by the CP and the domain joined by the device are different from each other.

If the device determines that the domain identifier is registered with the list of domain identifiers, the CP can join the domain. The device transports a response message to the CP (Operation 340). Since the domain to be joined by the CP and the domain joined by the device are identical to each other, the device allows the CP to control the device.

The device generates a control point identifier (CP-ID) indicating an authority for controlling the device, and transports the CP identifier via the response message in Operation 340. The CP identifier is registered with a list of CP identifiers corresponding to a list of CPs allowed to control the device. A [RESPONSE] message illustrated in FIG. 3B is the response message.

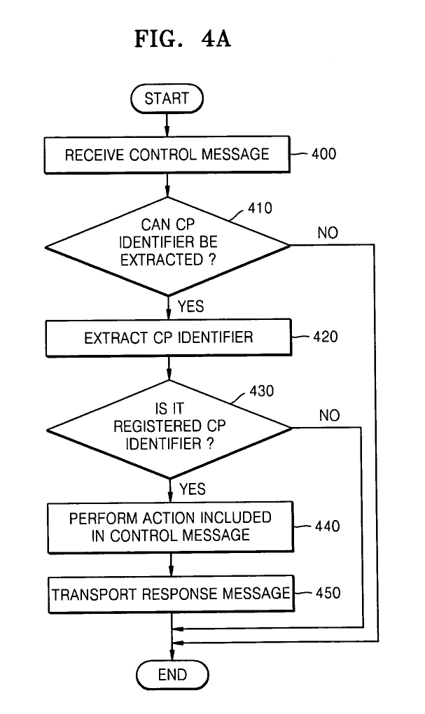

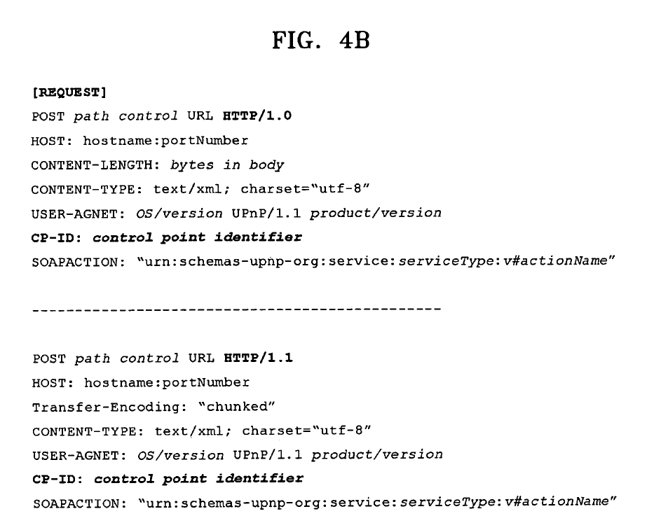

FIG. 4A is a flowchart of a control operation of the method of granting control of the device according to an embodiment of the present invention. Referring to FIG. 4A, the device receives a call of an action via a control message from the CP (Operation 400). An SOAP message corresponding to the call of the action includes a CP identifier added to an HTTP header. A [REQUEST] message illustrated in FIG. 4B is the control message.

The device determines whether to extract the CP identifier from the control message (Operation 410).

If the device determines that the CP identifier cannot be extracted from the control message, since the control message does not have a field of the CP-ID, the CP is not allowed to control the device. The device does not respond to the control message.

If the device determines that the CP identifier can be extracted from the control message, the device extracts the CP identifier from the HTTP header of the control message (Operation 420).

The device determines whether the CP identifier is registered with the list of the CP identifiers stored in Operation 340 (Operation 430).

If the device determines that the CP identifier is not registered with the list of CP identifiers, the device does not respond to the control message. Since the CP joins the same domain as that of the device and does not have the CP identifier included in the response message transported in Operation 340, the CP is not allowed to control the device.

If the device determines that the CP identifier is registered with the list of the CP identifiers, the device processes the control message and performs the action based on UPnP standards (Operation 440).

The device transports a response message to the CP (Operation 450). The response message includes a result obtained by performing the action in Operation 440 and the CP-ID. A [RESPONSE] message illustrated in FIG. 4B is the response message.

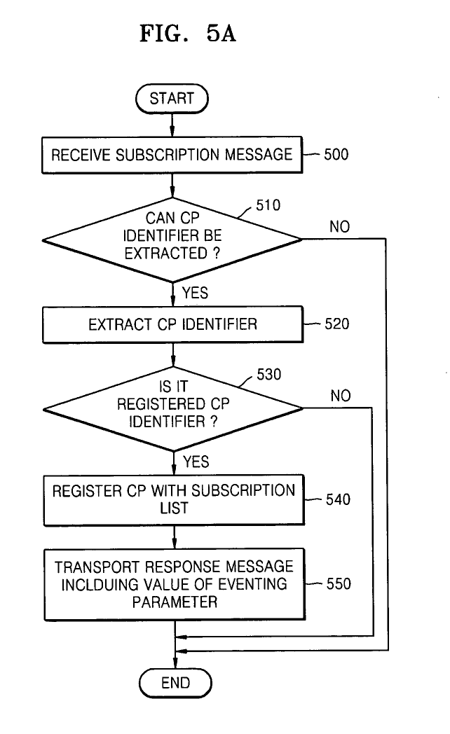

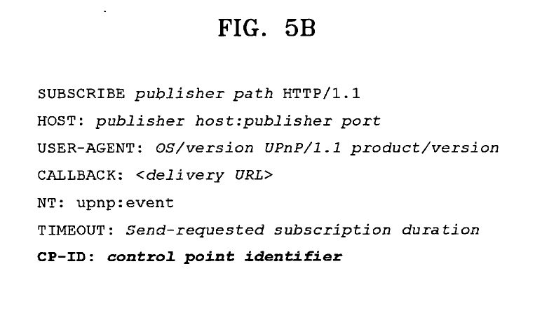

FIG. 5A is a flowchart of a subscription operation of the method of granting control of the device according to an embodiment of the present invention. Referring to FIG. 5A, the device receives a subscription message from the CP (Operation 500). The subscription message includes a CP identifier. A [REQUEST] message illustrated in FIG. 5B is the control message.

The device determines whether to extract the CP identifier from the subscription message (Operation 510).

If the device determines that the CP identifier cannot be extracted from the subscription message, since the subscription message does not has a field of the CP-ID, the device does not respond to the subscription message.

If the device determines that the CP identifier can be extracted from the subscription message, the device extracts the CP identifier from the subscription message (Operation 520).

The device determines whether the CP identifier is registered with the list of the CP identifiers stored in Operation 340 (Operation 530).

If the device determines that the CP identifier is not registered with the list of CP identifiers, since the CP is not allowed to control the device, the device does not respond to the subscription message. Since the CP joins the same domain as that of the device and does not have the CP identifier included in the response message transported in Operation 340, the CP is not allowed to control the device.

If the device determines that the CP identifier is registered with the list of the CP identifiers, the device registers the CP with a-subscription list corresponding to the list of the CPs that subscribed to the device (Operation 540).

The device transports a response message including an eventing parameter value of the device to the CP (Operation 550). The response message includes a CP-ID. A [RESPONSE] message illustrated in FIG. 5B is the response message.

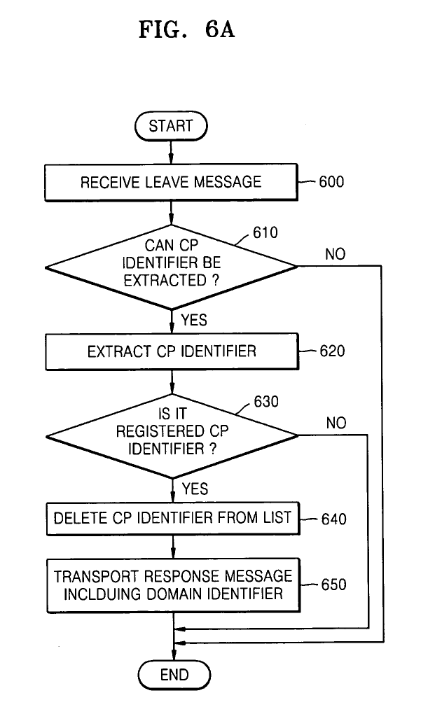

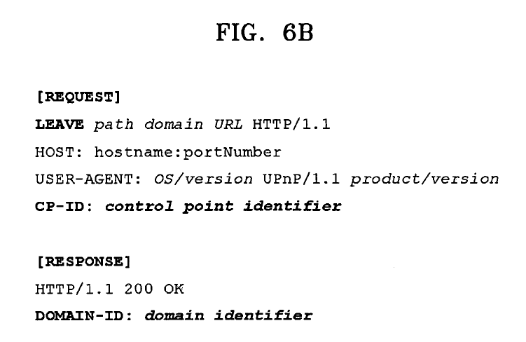

FIG. 6A is a flowchart of a leave operation of the method of granting control of the device according to an embodiment of the present invention. Referring to FIG. 6A, the device receives a leave message from the CP (Operation 600). The leave message indicates a leave from the domain joined by the CP and includes a CP-ID. A [REQUEST] message illustrated in FIG. 6B is the leave message.

The device determines whether the CP identifier can be extracted from the leave message (Operation 610).

If the device determines that the CP identifier cannot be extracted from the leave message, since the leave message does not have a field of the CP-ID, the device joins the domain and does not respond to the leave message.

If the device determines that the CP identifier can be extracted from the subscription message, the device extracts the CP identifier from the leave message (Operation 620).

The device determines whether the CP identifier is registered with the list of the CP identifiers stored in Operation 340 (Operation 630).

If the device determines that the CP identifier is not registered with the list of CP identifiers, the device does not respond to the leave message. Since the CP does not join the same domain as that of the device, the CP fails to receive the CP-IDA from the device.

If the device determines that the CP identifier is registered with the list of the CP identifiers, the device deletes the CP from the list of the CP-IDs stored in Operation 340 (Operation 640).

The device transports a response message to the CP (Operation 650). The response message includes a domain identifier. A [RESPONSE] message illustrated in FIG. 6B is the response message.

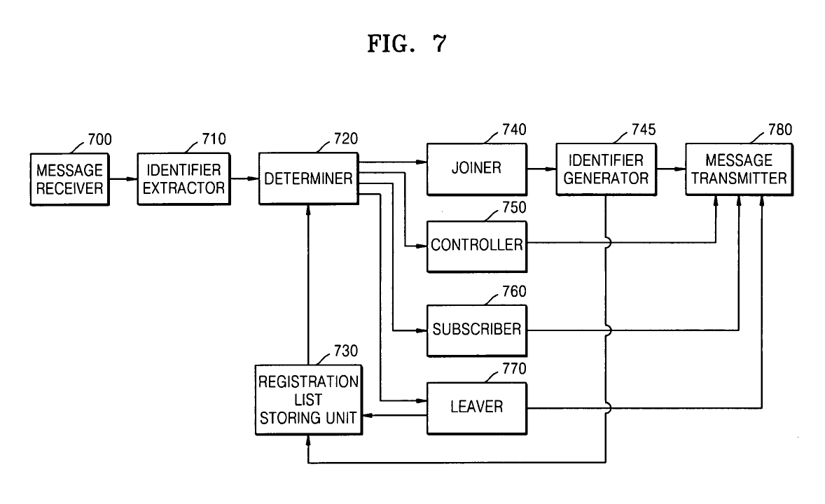

FIG. 7 is a block diagram of a device according to an embodiment of the present invention. Referring to FIG. 7, a message receiver 700 receives a join message, a control message, a subscription message, and a leave message from the CP.

An identifier extractor 710 extracts a domain identifier or a CP identifier from the messages received by the message receiver. The identifier extractor 710 extracts the domain identifier when received in the join message from the message receiver 700, and the CP identifier when received in the control message, the subscription message, and the leave message from the message receiver 700.

A determiner 720 determines whether the domain identifier or the CP identifier can be extracted from the identifier extractor 710. If the determiner 720 determines that the domain identifier or the CP identifier can be extracted from the identifier extractor 710, the determiner 720 determines whether the domain identifier or the CP identifier extracted from the identifier extractor 710 is identical to a domain identifier or a CP identifier stored in a registration list storing unit 730.

Whether to extract the domain identifier or the CP identifier from the identifier extractor 710 is determined according to whether a field of the domain identifier or the CP identifier extracted by the identifier extractor 710 is included in the messages received by the message receiver 700. If the determiner 720 determined that the domain identifier or the CP identifier cannot be extracted from the identifier extractor 710, the message receiver 700 does not respond to the messages.

The registration list storing unit 730 stores a list of identifiers of a domain joined by the device. A joiner 740 stores a list of CP identifiers generated by an identifier generator 745 with regard to CPs allowed to join a domain. A subscriber 760 stores a subscription list of CPs allowed to subscribe to the domain.

If the joiner 740 determines that the domain identifier extracted from the join message by the identifier extractor 710 is stored in the list of the CP identifiers of the registration list storing unit 730, the joiner 740 allows the CP to join the device.

The identifier generator 745 generates a CP identifier indicating an authority for controlling the device with regard to the CP allowed to join the domain by the joiner 740. Also, the identifier generator 745 writes the CP identifier in the registration list storing unit 730.

If a controller 750 determines that the CP identifier extracted from the control message by the identifier extractor 710 is stored in the registration list storing unit 730, the controller 750 performs an action called by the control message received by the message receiver 700.

If the subscriber 760 determines that the CP identifier extracted from the subscription message by the identifier extractor 710 is stored in the registration list storing unit 730, the subscriber 760 writes the CP identifier in the subscription list stored in the registration list storing unit 730, and generates a value of an eventing parameter of the device transmitted to the CP.

If a leaver 770 determines that the CP identifier extracted from the leave message by the identifier extractor 710 is stored in the list of the CP identifiers of the registration list storing unit 730, the leaver 770 deletes the CP identifier from the list of the CP identifiers stored in the registration list storing unit 730.

A message transmitter 780 transmits a response message to the message received by the message receiver 700 to the CP. The message transmitter 780 transports the CP identifier generated by the joiner 740 via a response message to the join message. Also, the message transmitter 780 transports the CP identifier via a response messages to the control message, the subscription message, or the leave message.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves.

According to the method of granting control of a device and a device using the method of the present invention, the device selectively allows a specific CP that joined a domain to control the device, so that the specific CP can control the device. Therefore, another CP that is connected to the same network but has not joined the domain cannot control the device.

While the present invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method of granting control of a specific device to a control point (CP) that controls at least one device, the method comprising:
determining whether the CP joined a domain joined by the specific device; and
allowing the CP to selectively control the specific device according to a result obtained by the determination.

2. The method of claim 1, wherein the CP is allowed to control the specific device if it is determined that the CP joined the domain.

3. The method of claim 1, wherein it is determined whether the CP joined the domain using an identifier of the CP indicating an authority for controlling the specific device.

4. The method of claim 3, wherein the identifier of the CP is generated when the specific device allows the CP to join a domain targeted by the CP.

5. The method of claim 1, further comprising:
the CP requesting to join an event indicating an eventing of the specific device; and
selectively transporting a message regarding the eventing of the specific device to the CP according to the result obtained by the determination.

6. The method of claim 1, further comprising:
the CP requesting a leave from the domain; and
leaving the CP from the domain according to the result obtained by the determination.

7. A method of granting control of a specific device to a CP that controls at least one device, the method comprising:
determining whether the CP can join a domain joined by the specific device; and
allowing the CP to selectively join the domain according to a result obtained by the determination.

8. The method of claim 7, wherein it is determined whether the CP can join the domain based on whether an identifier of a domain targeted by the CP is identical to an identifier of the domain joined by the specific device.

9. The method of claim 7, wherein the CP is allowed to selectively join the domain by generating an identifier of the CP indicating an authority for controlling the specific device and transporting the identifier to the CP.

10. A computer-readable storage medium having embodied thereon a computer program for executing a method of claim 1.

11. A device that grants control to a CP that controls at least one device, the device comprising:
a CP determiner which determines whether the CP joined a domain joined by the device; and
a control allowing unit which allows the CP to selectively control the device in response to a result obtained by the determination.

12. The device of claim 11, wherein the control allowing unit allows the CP to control the device if the CP determiner determines that the CP joined the domain.

13. The device of claim 11, wherein the CP determiner determines whether the CP joined the domain using an identifier of the CP indicating an authority for controlling the device.

14. The device of claim 13, wherein the identifier of the CP is generated when the device allows the CP to join the domain targeted by the CP.

15. The device of claim 11, further comprising:
a join determiner which determines whether the CP can join the domain joined by the device; and
a join allowing unit which allows the CP to selectively join the domain in response to the result obtained by the determination of the join determiner.

16. The device of claim 15, wherein the join determiner determines whether the CP can join the domain based on whether an identifier of the domain targeted by the CP is identical to an identifier of the domain joined by the device.

17. The device of claim 15, further comprising: an identifier generator which generates an identifier of the CP, which is allowed to join the domain, indicating an authority for controlling the device.

18. The device of claim 11, further comprising:
a subscription receiver which receives a request for joining an event indicating an eventing of the device from the CP; and
a subscription allowing unit which selectively transports a message regarding the eventing of the device to the CP in response to a result obtained by the determination of the CP determiner.

19. The device of claim 11, further comprising:
a leave receiver which receives a request for leaving the domain from the CP; and
a leave allowing unit which allows the CP to leave the domain in response to the result obtained by the determination of the CP determiner.
